(19) United States
(12) Patent Application Publication
(10) Pub. No.: US 2008/0066114 A1
(43) Pub. Date: Mar. 13, 2008

(54) TELEVISION GIFT OBJECT

(76) Inventors: MICHAEL P. CARLSON, Austin, TX (US); Linda A. Lisle, Cedar Park, TX (US); Herman Rodriguez, Austin, TX (US)

Correspondence Address: Greg Goshorn, P.C., 9600 Escarpment, Suite 745-9, AUSTIN, TX, 78749, US

(21) Appl. No.: 11/465,248

(22) Filed: Aug. 17, 2006

(51) Int. Cl. H04N 5/445; H04N 7/173; G06F 3/00; G06F 13/00

(52) U.S. Cl. 725/61; 725/86; 725/87; 725/37

(57) ABSTRACT

Provided is a method that enables a media subscriber to pay for and send pay-per-view media content to a third party. The subscriber is billed for the content in a normal fashion. The viewer selects a specific program that is scheduled for transmission and provides information about the identity of the other subscriber, or the recipient, so that the content can be delivered to the recipient. Additional information may include a reason for sending the program and an additional message. The recipient receives notification that the programming has been purchased on his or her behalf and is given the option of accepting or declining the program. If the recipient accepts the program, the recipient may specify a date and time for viewing or specify that the programming be recorded.

### TECHNICAL FIELD

The present invention relates generally to a method for providing a media subscriber with means to order media content and have the content delivered to a third party.

### BACKGROUND OF THE INVENTION

Over the last few decades, cable and Internet providers, in contrast to broadcast providers, have increasingly provided television signals to viewers. Cable and Internet providers typically have a data capacity that exceeds the transmission capacity of a broadcast provider by several magnitudes. In addition to providing a greater number of signals, or channels, the paradigm shift from broadcast to wired connections enables two-way communication between viewers and providers. In other words, not only can a viewer receive a signal from a provider, the viewer has the capability to transmit a signal to the provider.

One such business model based upon two-way communications is called pay-for-view. In pay-for-view, a television viewer can select a specific program from a list of programs on a particular channel, transmit a request for the program, receive the program and be billed for the program. This model is currently popular in sports programming. Typically, the charges for such an order is included in a normal invoice from the respective service provider.

Another service provided in conjunction with television, both wired and broadcast, is shopping for consumer products. Shopping channels display products for sale and viewers are encouraged to call a telephone number and order the products. In this type of service, the viewers provide product, credit card and delivery information to telephone operators to complete a particular transaction.

What is needed is a method and system that enables a television subscriber to order and pay for selected media content and have the content delivered to another viewer. For example, it would be advantageous if a viewer could select a particular movie, order and pay for the movie and have the movie delivered to a friend as a gift.

### SUMMARY OF THE INVENTION

Provided is a method that enables a media subscriber to pay for and send pay-per-view media content to a third party. The subscriber is billed for the content in a normal fashion, i.e. a charge is included in the subscriber's regular bill. One example is providing a television subscriber, or viewer, the ability enable a friend, or recipient, to watch a particular basketball game. It should be understood that the claimed technology applies equally well to media other than television and content other than sports. Although currently prevalent in television, pay-per-view may also become common in audio media and the claimed technology would be equally applicable.

The viewer selects a basketball game that is scheduled for transmission and provides information about the identity of the other subscriber, or the recipient, so that the content can be delivered to the recipient. Additional information may include a reason for sending the program and an additional message. For example, the additional message may be a personal greeting expressing wishes that the recipient enjoy a happy birthday.

The recipient receives notification that the programming has been purchased on his or her behalf and is given the option of accepting or declining the program. If the recipient accepts the program, the recipient may specify a date and time for viewing. In other words, the recipient may select to view the basketball game at some time later then the scheduled transmission time. In that case, during the scheduled transmission time, the basketball game is stored to a hard drive or other memory. Once stored, the program may either be viewed at a specified date and time or on-demand like any other stored program.

The claimed subject matter may be a stand-alone product or integrated with commercially available products such as cable receiver/recorders and computer calendar/scheduling programs. In addition, a content provider may offer the claimed subject matter as a service to senders and recipients. This summary is not intended as a comprehensive description of the claimed subject matter but, rather, is intended to provide a brief overview of some of the functionality associated therewith. Other systems, methods, functionality, features and advantages of the invention will be or will become apparent to one with skill in the art upon examination of the following figures and detailed description.

### BRIEF DESCRIPTION OF THE FIGURES

A better understanding of the present invention can be obtained when the following detailed description of the disclosed embodiments is considered in conjunction with the following figures, in which:

FIG. 1 is an exemplary multimedia system architecture that includes a media access device (MAD), implemented according to the claimed subject matter.

FIG. 2 is a block diagram of the MAD of FIG. 1 in more detail.

FIG. 3 is an illustration of a program selection graphical user interface (GUI) employed to implement the claimed subject matter on the sender side.

FIG. 4 is an illustration of a program notification GUI employed to implement the claimed subject matter on the recipient side.

FIG. 5 is a flowchart of a program selection process that enables a first viewer to select programming for display to a second viewer.

FIG. 6 is a flowchart of a gift program execution process for implementing the claimed subject matter.

FIG. 7 is a flowchart of a program display process for presenting the selected program to the second viewer.

### DETAILED DESCRIPTION OF THE FIGURES

Although described with particular reference to internet-enabled (IP) television, the claimed subject matter can be implemented in any media system in which a capacity to transmit programming to a third party is desirable. Those with skill in the computing and communication arts will recognize that the disclosed embodiments have relevance to a wide variety of computing and communication environments in addition to those described below. In addition, the methods of the disclosed invention can be implemented in software, hardware, or a combination of software and hardware. The hardware portion can be implemented using specialized logic; the software portion can be stored in a memory and executed by a suitable instruction execution system such as a microprocessor, personal computer (PC) or mainframe.

In the context of this document, a “memory” or “recording medium” can be any means that contains, stores, communicates, propagates, or transports the program and/or data for use by or in conjunction with an instruction execution system, apparatus or device. Memory and recording medium can be, but are not limited to, an electronic, magnetic, optical, electromagnetic or semiconductor system, apparatus or device. Memory an recording medium also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

One embodiment, in accordance with the claimed subject, is directed to a programmed method for transmitting gifts among subscribers of a multi-media communication service. The term “programmed method”, as used herein, is defined to mean one or more process steps that are presently performed; or, alternatively, one or more process steps that are enabled to be performed at a future point in time. The term “programmed method” anticipates three alternative forms. First, a programmed method comprises presently performed process steps. Second, a programmed method comprises a computer-readable medium embodying computer instructions, which when executed by a computer performs one or more process steps. Finally, a programmed method comprises a computer system that has been programmed by software, hardware, firmware, or any combination thereof, to perform one or more process steps. It is to be understood that the term “programmed method” is not to be construed as simultaneously having more than one alternative form, but rather is to be construed in the truest sense of an alternative form wherein, at any given point in time, only one of the plurality of alternative forms is present.

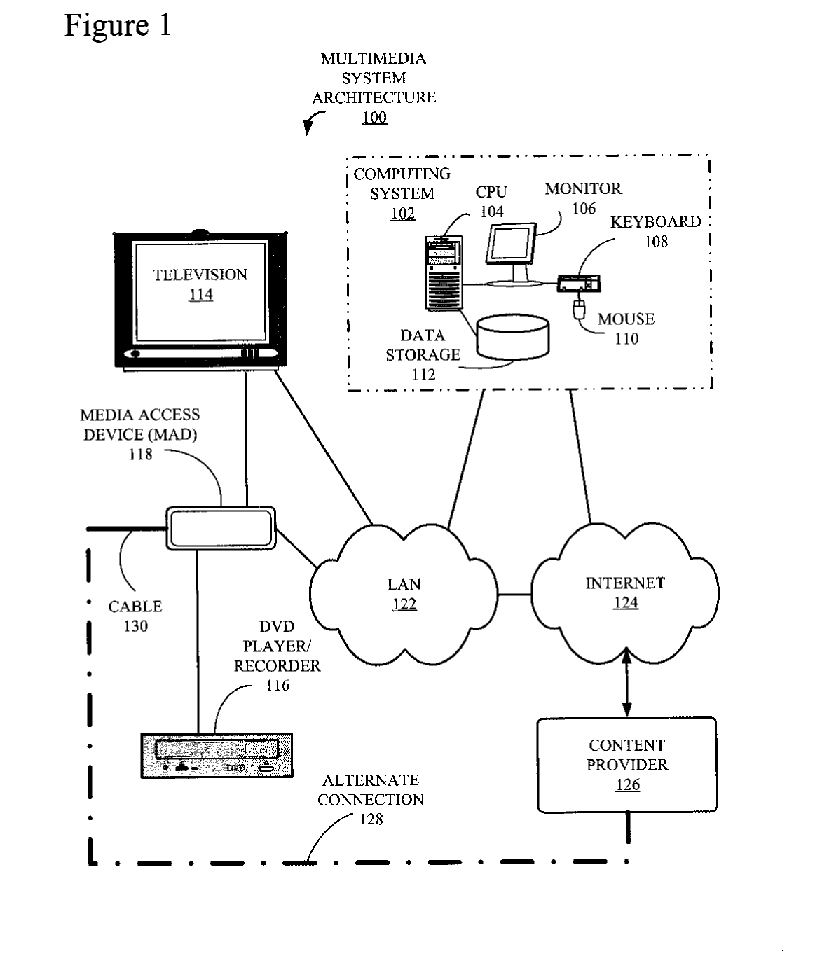

FIG. 1 is an exemplary multimedia system architecture 100 that includes a media access device (MAD) 118, implemented according to the claimed subject matter. Architecture 100 includes several devices, including a computing system 102, a television 114, and a DVD player/recorder 116. Devices 102, 114 and MAD 118 are communicatively coupled to a local area network (LAN) 122. The connections between LAN 122 and devices 102, 114, 116 and MAD 118 may be, but are not limited to, direct, wired connections, wireless connections or via a LAN hub (not shown). LAN 122 and computing system 102 are also coupled to the Internet 124. Each of devices 114, 116 and 118 may also be communicatively coupled to Internet 124 via LAN 122, computing system 102 or both. Those with skill in the computing and communication arts should appreciate that there are many possible methods for connecting devices to each other in addition to instead of LAN 122 and the Internet 124. The elements of FIG. 1 are used only for the purposes of describing the claimed subject matter and are not intended to limit the claims.

It should be noted that, although devices 102, 114 116 and 118 are illustrated as separate devices; a large degree of integration is possible. For example, the functionality of MAD 118 may be incorporated into computing system 102 and/or television 114 or the recording and playback capabilities of DVD player/recorder 116 may be incorporated into television 114 and MAD 118. In addition, the functionality of MAD 118 may be provided by a content provider 126 as a service. Those with skill in the relevant arts should appreciate the extent to which the capabilities of such devices are currently, and may be, integrated into single units.

Computing system 102 includes a central processing unit (CPU) 104, coupled to a monitor 106, a keyboard 108 and a mouse 110, which together facilitate human interaction with computer 102. Also included in computer 102 and attached to CPU 104 is a data storage component 112, which may either be incorporated into CPU 104 i.e. an internal device, or attached externally to CPU 104 by means of various, commonly available connection devices such as but not limited to, a universal serial bus (USB) port (not shown).

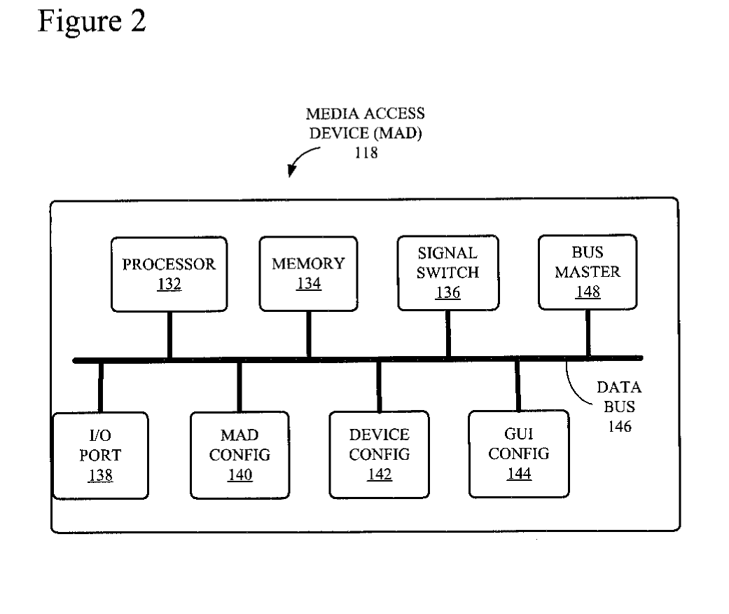

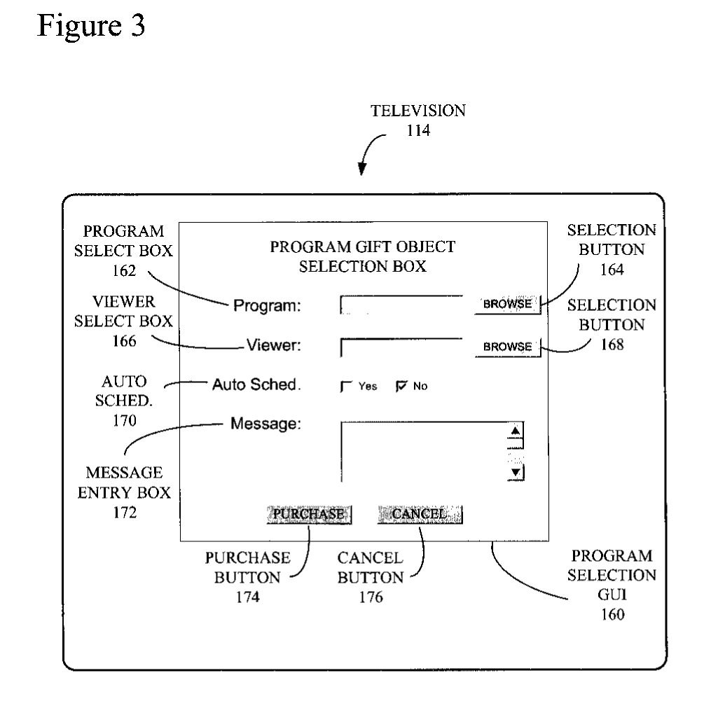

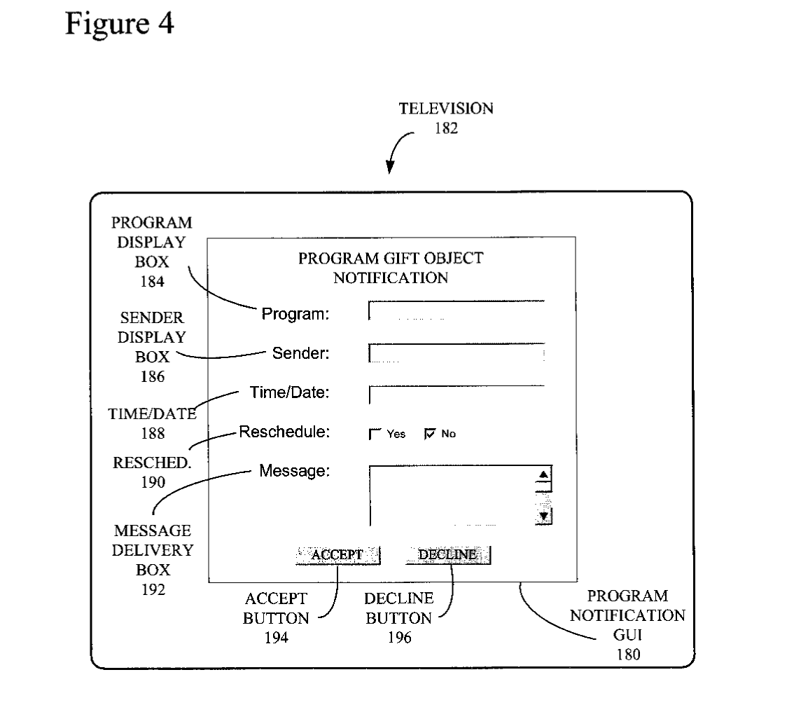

In this example, television 114 and MAD 118 are Internet-enabled or, in other words, are able to download an appropriate signal from Internet 124. MAD 118 is configured to monitor the types of signals processed by television 114, regardless of whether device 114 is powered on or off. In this example, programming signals are transmitted by content provider 126 via Internet 124. Content provider 126 is also shown with an alternative connection 128 that transmits a signal to MAD 118 via a cable 130. MAD 118 is coupled to cable 130 and both monitors cable 130 and relays appropriate signals from cable 130 to television 114 and DVD player/recorder 116. MAD 118 is also configured to send signals to television 114 and DVD player/recorder 116. In the appropriate circumstances, the signals from MAD 118 generate graphical user interfaces (GUIs) on television 114 that enable a viewer to select a program to transmit to a receiver and enable the receiver to, among other things, accept or decline such a gift. Two exemplary GUIS are illustrated in FIGS. 3 and 4. Setup, operation and the purpose of the signals from MAD 118 to devices 114 and 116 are described in more detail below in conjunction with FIGS. 2-7.

FIG. 2 is a block diagram of MAD 118 of FIG. 1 in more detail. Functional modules include a processor 132, a memory 134, a signal switch 136, an Input/Output (I/O) port 138, a MAD configuration (config.) module 140 a device config. module 142 and a GUI config. module 144. Each of modules 132, 134, 136, 138, 140, 142 and 144 are coupled to a data bus 146, which enables modules 132, 134, 136, 138, 140, 142 and 144 to communicate with each other. Traffic on data bus 146 is controlled by a bus master 148.

Processor 132 controls the coordination of modules 134, 136, 138, 140, 142 and 144 while executing the claimed subject matter. Memory 134 provides storage for data and executables employed by processor 132. Signal switch 136 enables a user to select particular programming signals from computing system 102 (FIG. 1), DVD player/recorder 116 (FIG. 1), cable 130 (FIG. 1) and Internet 124 (FIG. 1) and transmit the signals to computing system 102, television 114 and DVD player/recorder 116 for viewing and/or recording.

Input/Output (I/O) port 138 handles communication between MAD 118 and target devices such as computing system 102 and DVD player/recorder. In addition, I/O port 138 transmits signals from Internet 124 and cable 130 to the appropriate device in architecture 100. MAD configuration module 140 provides involatile storage for information employed in the claimed subject matter. Simply stated, module 140 stores information related to the internal configuration of MAD 118.

Device config. module 142 stores information relating to the devices, such as television 114 and DVD player/recorder 116, of architecture 100 (FIG. 1) that may receive a control signal and/or GUIs from MCD 118. Specifically, device config. module 142 stores information relating to the formatting of commands and GUIs to target devices. Examples of commands include, but are not limited to, commands to DVD player/recorder 116 to record or transmit a particular media stream. GUI config. module 144 stores information related to various GUIs generated by MAD 118. Types of GUIs generated by MAD 118 include, but are not limited to program sending screens (see FIG. 3), program receiving screens (see FIG. 4) and various configuration setup screens (not shown). The various components of MAD 118 and the respective functionalities are explained in more detail below in conjunction with FIGS. 3-7.

FIG. 3 is an exemplary program selection graphical user interface (GUI) 160 employed by a viewer to select a program and another viewer, or recipient, to which to send the selected program. Throughout this specification, the user selecting and paying for the media content is described as the “viewer,” although it should be noted that the claimed subject matter is not only applicable to content that can be “viewed.” For example, the claimed subject matter is equally applicable to audio content. In addition, a third party to whom the content is transmitted is referred to as the “recipient.”

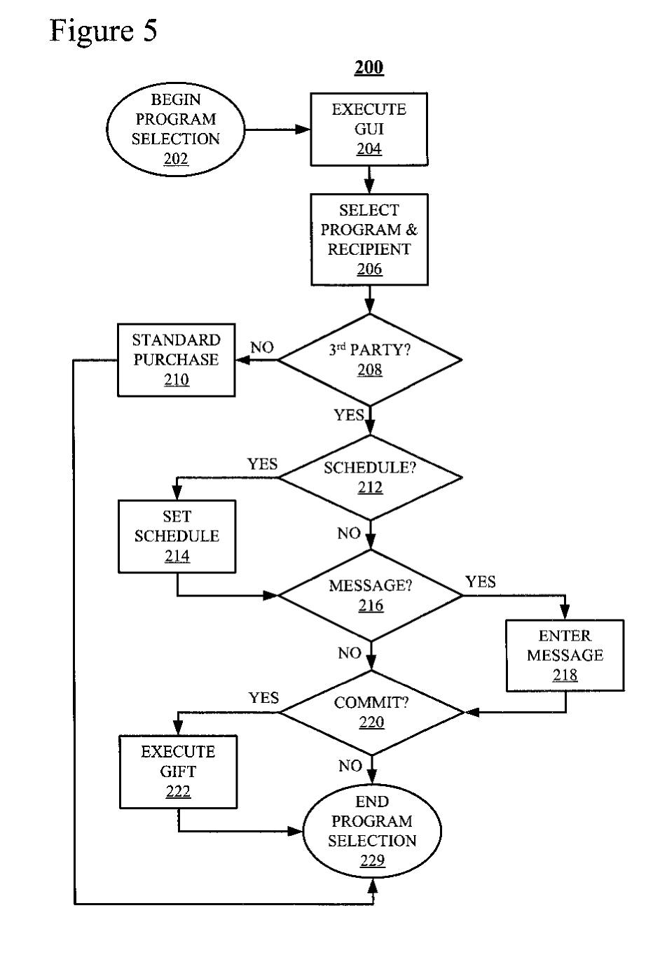

In this example, GUI 160 is displayed on television 114 (FIG. 1) and information is entered via a controller (not shown) associated with television 114. It should be understood that GUI 160 could also be displayed on monitor 106 (FIG. 1) of computing system 102 (FIG. 1) or on a display (not shown) coupled to MAD 118 (FIGS. 1 and 2). A program selection process 200 that generates GUI 160 is explained in detail below in conjunction with FIG. 5.

Included in program selection GUI 160 is a program select entry box 162. A viewer enters information relating to a particular program into entry box 162. A particular program may be identified in a variety of ways such as by name, program number, date/time/channel information and so on. A selection button 164 displays a channel guide (not shown) that enables the viewer to select a program graphically from a list of available programs. A viewer select entry box 166 enables the viewer to select one or more third parties to whom the program selected in entry box 162 is to be transmitted. A particular third party recipient may be identified by name, identification number or any other method that MAD 118 is configured to recognize. A selection button 168 causes a list of available third parties to whom the viewer may transmit a program selection to be displayed and the viewer, using an appropriate controller, may select one or more. A particular content provider may require that only third party recipients who have agreed to accept programming from a particular viewer be included in a list of recipients; i.e. a purchaser/third-party recipient relationship must be configured in advance by mutual agreement among the parties.

Auto scheduling buttons 170 enable the viewer to specify whether or not the program identified in box 162 is automatically entered into the programming schedule of the recipient entered in box 164, subject to the recipient's acceptance of the program (see FIG. 4). If the “Yes” box is selected, a GUI (not shown) is displayed that enables the viewer to select a particular time for viewing. The date/time GUI may be generated by a calendar program (not shown) that is compatible with the disclosed technology. A message entry box 172 enables the viewer to transmit a personal message to the selected recipient(s) in conjunction with the programming selection notification.

Finally, a purchase button 174 enables the viewer to commit to the transaction. Typically, upon activation of button 174, the viewer is presented with a payment GUI (not shown) that enables the viewer to specify a method of payment. In the alternative, the media provider that offers the service represented by the claimed subject matter may automatically add payment to the viewer's monthly service bill. A cancel button 176 enables the viewer to exit GUI 160 without purchasing a program.

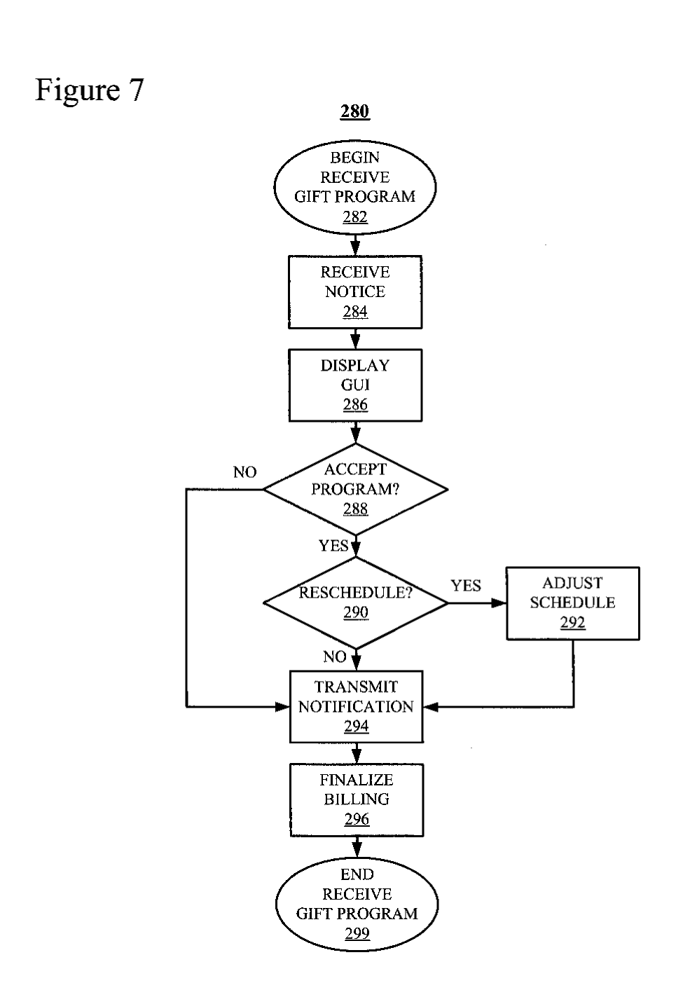

FIG. 4 is an illustration of a program notification GUI 180 employed to implement the claimed subject matter on the recipient side. In this example, GUI 180 is displayed on a television 182 (not shown) associated with the recipient identified in viewer select entry box 166 (FIG. 3). Information is entered via a controller (not shown) associated with a television 182. It should be understood that GUI 180 could also be displayed on a computer monitor such as monitor 106 (FIG. 1) of computing system 102 (FIG. 1) or on a display (not shown) coupled to a MAD 118 (FIGS. 1 and 2) connected to television 182. A Receive Gift Programming process 280 associated with GUI 180 is described below in conjunction with FIG. 7.

Included in program notification GUI 180 is a program display box 184. Box 184 informs the recipient of the program that was selected in program select entry box 162 (FIG. 3) by the viewer sending the program. A particular program may be identified in a variety of ways such as by name, program number, date/time/channel information and so on. The program that is the subject of the notification may also be displayed graphically as part of a list of available programs. A sender display box 186 informs the recipient of the program displayed in box 184 of the identity of the sender. A particular sender may be identified by name, identification number or any other method that MAD 118 is configured to recognize.

If the sender selected a time and date by checking the Yes button of auto schedule buttons 170 (FIG. 3) when the program was selected, a time/date box 188 provides the recipient of the corresponding program of the scheduled time and date for display on television 182. Reschedule buttons 190 enable the recipient to set an alternative data and time. If the recipient decides to reschedule the selected time and date by clicking the “Yes” button or if the sender did not select a specific time and date for viewing, a pop-up GUI (not shown) displays a calendar so that the recipient can make a selection graphically. The calendar may be tied into a standard calendar program such as Microsoft Outlook, published by Microsoft Corporation of Redmond, Wash. The pop-up scheduling GUI also provides the recipient the ability to specify that the transmitted program be recorded for later viewing on a DVD player/recorder such as player/recorder 116 (FIG. 1) or some other available recording media.

A message delivery box 192 displays a message entered by the sender in message entry box 172 (FIG. 3). Finally, an accept button 194 enables the recipient to accept the programming transmitted by the sender on date and time specified in GUI 180. A decline button 196 enables the recipient to refuse acceptance of the programming. If the recipient refuses the programming, the sender is notified and charges associated with the program are not added to the sender's invoice.

FIG. 5 is a flowchart of program selection process 200. Process 200 enables a first viewer to select programming for display to a second viewer, or recipient, in accordance with the claimed subject matter. In this example, process 200 is stored in memory 134 (FIG. 2) and executed on processor 132 (FIG. 2) of MAD 118 (FIGS. 1 and 2). Process 200 generates GUI 160 (FIG. 3) on television 114 (FIGS. 1 and 3) to enable a viewer to implement the claimed subject matter. As explained above in conjunction with FIG. 3, television 114 and MAD 118 are used for illustrative purposes only. For example, process 200 could be implemented on computing system 102 (FIG. 1) and GUI 160 could be displayed on monitor 106 (FIG. 1). In the alternative, process 200 is executed on equipment of media provider 126 as a service and transmitted to television 114.

Process 200 starts in a “Begin Program Selection” block 202 and control proceeds immediately to an “Execute GUI” block 204. During block 204, process 200 generates GUI 160 on television 114. During a “Select Program and Recipient” block 206, a user selects a program to purchase and may identify a third party recipient to whom to send the selected program. The selection of a particular program may be accomplished by means of a graphical presentation of a channel schedule (not shown) or by entering information into program select box 162 (FIG. 3) that uniquely identifies the particular program, as explained above in conjunction with FIG. 3. The mechanics of program selection should be known by anyone who uses a cable box to record a program or select a pay-per-view program. The difference between the disclosed technology and the prior art related to recording or purchasing a pay-per-view program is the added capability of specifying a recipient for the selected program. If the viewer desires to transmit the program selected in box 162, information identifying a third party recipient is entered in viewer select box 166 (FIG. 3).

During a “3^{rd} Party?” block 208, process 200 determines whether or not the program selected during block 206 is for delivery to a third party. Typically, process 200 determines that a third party recipient is not intended if the viewer leaves box 166 blank. In that case, process 200 proceeds to a “Standard Purchase” block 210. During block 210, typical pay-to-view procedures are employed for the viewer to receive the requested programming. If process 200 determines during block 208 that the information entered into block 166 is a valid third party recipient, process 200 proceeds to a “Schedule?” block 212. During block 212, process 200 determines whether or not the viewer has selected to automatically schedule the data and time the third party identified in box 166 can view the programmed identified in box 162. In this regard, process 200 is controlled by whether the “Yes” or “No” box of auto scheduling check boxes 170 (FIG. 3) has been checked.

If process 200 determines that the viewer has chosen to schedule the viewing time of the chosen program, i.e. the “Yes” box of boxes 170 is checked, control proceeds to a “Set Schedule” block 214. During block 214 process 200 generates a date/time GUI (not shown) that enables the viewer to select a specific viewing time and date. As explained above in conjunction with FIG. 3, the date/time GUI may be generated by a calendar program (not shown) that is compatible with the disclosed technology. Following block 214, or if during block 212 process 200 determines that the viewer has chosen not to schedule the program selected during block 206, process 200 proceeds to a “Message?” block 216.

During block 216, process 200 determines whether or not the viewer has chosen to enter a message in conjunction with the program selected during block 206. If so, process 200 proceeds to an “Enter Message” block 218 during which the viewer enters the desired message in message entry box 172 (FIG. 3). Following block 218 or if during block 216 process 200 determines that the viewer has chosen not to enter a message, process 200 proceeds to a “Commit?” block 220.

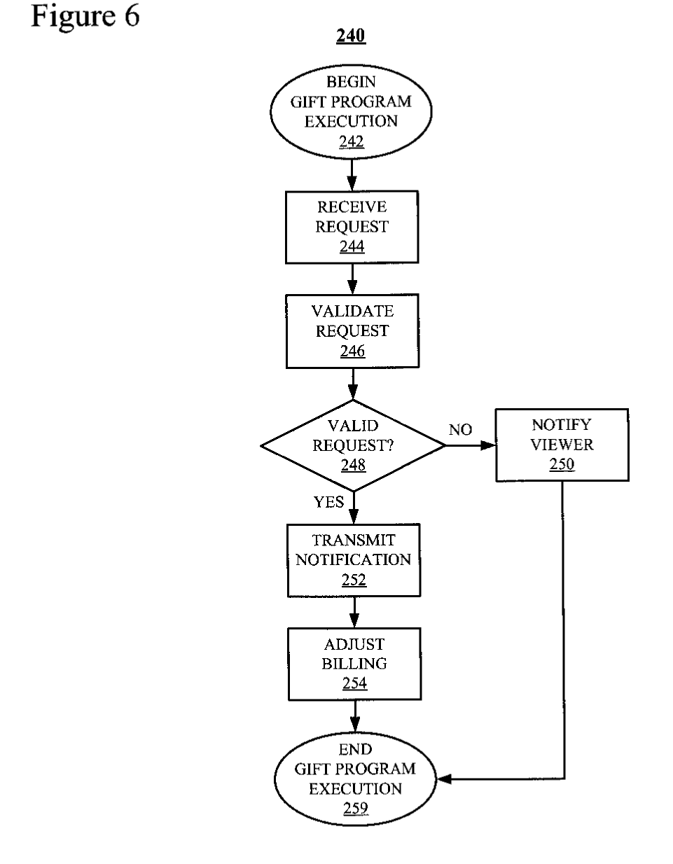

During block 220, process 200 determines whether or not the viewer has decided to commit or cancel the transaction. As explained above this decision is determined by whether the viewer clicks on Purchase button 174 (FIG. 3) or Cancel button 176 (FIG. 3). If the viewer decides to commit to the transaction, i.e. clicks on purchase button 174, process 200 proceeds top an “Execute GIFT” block 222. During block 222, process 200 executes the actions necessary to implement the requested purchase, specifically transmitting the request to content provider 126 (FIG. 1). The process of executing the requested purchase by content provider 126 is explained in a Gift Program Execution process 240 described below in conjunction with a FIG. 6.

Finally, after a standard program purchase has been executed during block 210, after process 200 has executed a requested purchase according to the claimed subject matter during block 222, or after process 200 has determined that the viewer is canceling the purchase during block 220, control proceeds to an “End Program Selection” block 229 during which process 200 is complete.

FIG. 6 is a flowchart of a gift program execution process 240 for implementing one aspect of the claimed subject matter. Program 240 is initiated by Execute Gift block 222 described above in conjunction with FIG. 5. Process 240 starts in a “Begin Gift Program Execution” block 242 and proceeds immediately to a “Receive Request” block 244. During block 244, content provider 126 (FIG. 1) receives a request to provide specific programming to a particular third-party recipient specified by a viewer. During a “Validate Request” block 246, content provider 126 evaluates the request received during block 244 for completeness and accuracy. For example, content provider checks that the viewer transmitting the received request is authorized to make the request, the program selected is a valid program and the third-party recipient is a customer authorized and configured to receive such a request.

During a “Valid Request?” block 248, process 240 determines whether or not the request received during block 244 is a valid and executable request based upon the evaluation executed during block 246. If not, the viewer that transmitted the request is sent a notification during a “Notify Viewer” block 250. If process 240 determines that the request is valid, control proceeds to a “Transmit Notification” block 252 during which process 240 transmits a message to the intended third-party recipient. The notification is described associated with GUI 180, described above in conjunction with FIG. 4, and Receive Gift Program process 180, described below in conjunction with FIG. 7.

During an “Adjust Billing” block 254, process 240 makes an entry in a billing record (not shown) associated with the viewer who requested that the programming be transmitted to the third-party recipient. Of course, depending upon whether or not the recipient accepts the gift, the transmitting viewer may or may not be eventually charged for the programming. Finally, following block 254 and block 250, process 240 proceeds to an “End Gift Program Execution” block 259 in which process 240 is complete.

FIG. 7 is a flowchart of Receive Gift Program process 280 for presenting the selected program to the selected third-party viewer. Process 280 is initiated in conjunction with GUI 180 (FIG. 4) and typically executed on a MAD (not shown), like MAD 118 (FIGS. 1 and 2), associated with the intended recipient of the programming request transmitted by process 200 (FIG. 5).

Process 280 starts in a “Begin Receive Gift Program” block 282 and proceeds immediately to a “Receive Notice” block 284. During block 284, the MAD of recipient receives a notice of the intended gift. During a “Display GUI” block 286, in response to the notice received during block 284, the recipeint's MAD displays GUI 180 on television 182 (FIG. 4). In the alternative, the functionality of the recipient's MAD may be located in a computing system associated with content provider 126 and content provider 126 receives notification and transmits GUI 180 to television 182 (FIG. 4) for display. As explained above in conjunction with FIG. 4, GUI 180 displays the selected program, the sender of the program and the scheduled time and date, if specified and the recipient takes actions to accept, decline and/or schedule the viewing of the specified program.

During an “Accept Program?” block 288, process 280 determines whether the recipient has accepted the specified program by checking accept button 194 (FIG. 4) or declined the program by checking decline button 196 (FIG. 4). If the recipient accepts the program, process 280 determines during a “Reschedule?” block 290 whether the selected program has been rescheduled or specified for recording on DVD player/recorder 116 (FIG. 1). As explained above in conjunction with FIG. 4, this determination is based upon the recipient's entries in reschedule? Box 190. If the recipient has specified an alternative time, process 280 proceeds to an “Adjust Schedule” block 292 during which the requested scheduling of the program is implemented.

Following block 288, block 290 if there is no rescheduling of the specified program or block 292 if the program has been rescheduled, process 280 proceeds to a “Transmit Notification” block 294. During block 294, both the sender of the specified program and content provider 126 are notified of the recipient's selections concerning acceptance and scheduling of the program. During a “Finalize Billing” block 296, process 280 appropriately adjusts the sender's billing records. Finally, control proceeds to an “End Receive Gift Program” block 299 in which process 280 is complete.

While the invention has been shown and described with reference to particular embodiments thereof, it will be understood by those skilled in the art that the foregoing and other changes in form and detail may be made therein without departing from the spirit and scope of the invention, including but not limited to additional, less or modified elements and/or additional, less or modified blocks performed in the same or a different order.

We claim:

1. A method for delivery of media programming, comprising:
selecting programming for presentation, wherein the programming is selected on a first media delivery device by a first party for presentation to a second party on a second media delivery device;
transmitting a notification to the second party informing the second party of the programming selection by the first party;
invoicing the first party for the selected programming; and
presenting the selected programming to the second party on the second media delivery device.

2. The method of claim 1, further comprising specifying, by the first party, a time and date for the presentation of the selected programming to the second party.

3. The method of claim 1, further comprising:
receiving an acceptance from the second party prior to presenting the selected programming on the second media delivery device; and
presenting the selected programming to the second party and invoicing the first party only if the acceptance is received.

4. The method of claim 1, wherein the programming is pay-for-view television programming.

5. The method of claim 1, wherein the first media delivery device and the second media delivery device are televisions.

6. The method of claim 1, further comprising providing the second party means for scheduling the presentation of the selected programming on the second media delivery device.

7. The method of claim 1, further comprising transmitting a personal message from the first party to the second party in conjunction with the notification.

8. A system for delivery of media programming, comprising:
a first media delivery device;
logic for selecting programming for presentation on a second media delivery device, wherein the programming is selected on the first media device by a first party for presentation to a second party;
logic for invoicing the first party for the selected programming; and
logic for transmitting a notification to the second party informing the second party of the programming selection by the first party.

9. The system of claim 8, further comprising logic for specifying, by the first party, a time and date for the presentation of the selected programming to the second party.

10. The system of claim 8, further comprising:
logic for receiving an acceptance from the second party prior to presenting the selected programming on the second media device; and
logic for presenting the selected programming to the second party and invoicing the first party only if the acceptance is received.

11. The system of claim 8, wherein the programming is pay-to-view television programming.

12. The system of claim 8, wherein the first media device and the second media device are televisions.

13. The system of claim 8, further comprising logic for scheduling the presentation of the selected programming by the second party on the second media device.

14. The system of claim 8, further comprising logic for transmitting a personal message from the first party to the second party in conjunction with the notification.

15. A method for providing the service of delivery of media programming, comprising:
presenting a plurality of programming choices to a first party on a first media delivery device;
receiving from the first party a selection of a specific programming choice from the plurality of programming choices;
transmitting a notification to a second party informing the second party of the specific programming choice;
invoicing the first party for the selected programming choice; and
presenting the specific programming selection on a second media delivery device corresponding to the second party.

16. The method of claim 15, further comprising providing means to the first party for specifying a time and date for the presentation of the selected programming to the second party.

17. The method of claim 15, further comprising:
receiving an acceptance from the second party prior to presenting the selected programming choice on the second media delivery device; and
presenting the selected program to the second party and invoicing the first party only if the acceptance is received.

18. The method of claim 15, wherein the programming choice is pay-for-view television programming.

19. The method of claim 15, further comprising providing the second party means for scheduling the presentation of the selected programming choice on the second media delivery device.

20. The method of claim 15, further comprising transmitting a personal message from the first party to the second party in conjunction with the notification.
